(19) United States
(12) Patent Application Publication
(10) Pub. No.: US 2010/0139501 A1
(43) Pub. Date: Jun. 10, 2010

(54) DECOUPLED PRESSURISED RETORT

(75) Inventors: Herbert Cordes, Verden/Aller (DE); Gebhard Kregel, Verden/Aller (DE)

Correspondence Address: FULBRIGHT & JAWORSKI, LLP, 1301 MCKINNEY, SUITE 5100, HOUSTON, TX, 77010-3095, US

(73) Assignee: Mars Corproation, McLean, VA (US)

(21) Appl. No.: 12/513,633

(22) PCT Filed: Dec. 17, 2007
(86) PCT No.: PCT/EP07/11054

§ 371 Date: Jan. 15, 2010

(30) Foreign Application Priority Data
Dec. 29, 2006 (DE) 10 2006 062 086.0

(51) Int. Cl. A23L 3/10; A23L 3/14

(52) U.S. Cl. 99/470; 99/477; 99/483

(57) ABSTRACT

The present invention relates to a pressurized retort with at least one container disposed therein. The container is movable in the retort via a drive and the container is supported by at least one bearing in the retort, wherein one or more compensator(s) is/are attached to the retort to provide a decoupling between the interior of the retort, the retort itself and the exterior of the retort.

### CROSS-REFERENCE TO RELATED APPLICATIONS

This Application is a National stage of International Application PCT/EP2007/011054 filed on Dec. 17, 2007 which claims priority to Application 10 2006 062 086.0-41 filed on Dec. 29, 2006 in Germany.

### TECHNICAL FIELD

The present invention relates to a pressurized retort with at least one container disposed therein, the container being movable in the retort via a drive and the container being supported by at least one bearing in the retort.

### BACKGROUND OF THE INVENTION

Pressurized retorts are used, for example, in the sterilization of foodstuffs which are to be packed in tins. Foodstuffs packed in tins require different processing times for sterilization, depending on their viscosity.

Whereas comparatively low-viscosity products allow convective heat to be introduced into the product very quickly by thermal conductivity, it takes considerably longer in the case of more viscous products until the temperature of preferably 115-130 C needed for sterilization has been distributed evenly throughout the tin. This leads to a long heating-up time, entailing increased costs and a low throughput. Lower-viscosity products only have to be sterilized for about 15-20 minutes, whereas more viscous products require a sterilization time of about 80-90 minutes. As a consequence of being exposed to heat for such a long time, however, the product can be overcooked in the interior of the tin or can burn onto the wall of the tin.

Studies in the state of the art have shown that the sterilization time can be reduced by moving the tin inside the sterilization retorts.

EP 0 804 095 B1, for example, discloses that, by means of a reciprocating horizontal movement of the tin, i.e. by accelerating and decelerating it, sharp reductions in the sterilization times can be achieved if the acceleration exceeds a particular value.

In order to move containers inside a pressurized retort, for sterilization purposes, for example, a drive is necessary, which has to be integrated into such a retort. In this context, it is essential that only the desired container is moved inside the retort, but that the pressurized retort per se is substantially completely insulated from forces and vibrations that might arise as a consequence of the movement. The term “container” in the present application is intended to mean any container in which, for example, glasses, pouches or dishes with contents to be sterilized can be placed. A container of this kind can therefore be a cage or basket, for example, or a tray on which, for example, the pouch to be sterilized can be fixed and a plurality of trays can be stacked on top of one another. A pressurized retort involved in thermal treatment is a very complex system with a large number of very sensitive sensors, such as calibrated instruments for measuring the temperature and pressure, means for monitoring the filling levels, and control valves, which can easily be damaged. In other words, it is necessary, among other things, to avoid the introduction of mass forces into the retort which result from the acceleration of the containers disposed in the retort. As far as possible, all the forces should be absorbed outside the retort housing and preferably dissipated into the foundation.

This means that, in this connection, the conditions inside and outside the container in the retort or in the retort itself have to be taken into account. All the components inside the retort come into contact with the energy source, such as steam, hot water or hot air, and are subjected to a thermal load. This means that the thermal expansion of the components, their temperature resistance and also the elevated internal pressure, usually a maximum of 6 bar, have to be taken into account. Outside the retort, more or less standard conditions prevail. If the areas inside and outside the retort are to be coupled together, in particular the thermal expansion and the sealing of the components conducted through the wall of the retort must be taken into consideration.

In this context, it is particularly desirable, since this is a pressurized vessel, that no vibrations, forces and moments should be introduced into the wall of the retort, in order not to have any negative influence on the status of the retort.

The retorts known from the state of the art, in which containers are moved, still have disadvantages with regard to the conditions described above. In addition, all that is known from the state of the art so far is that only a single container is placed in a retort, which has made it impossible to construct larger production facilities.

It is therefore an object of the present invention to provide a pressurized retort which overcomes the disadvantages of the state of the art.

### BRIEF SUMMARY OF THE INVENTION

This object is achieved in accordance with the invention in that one or more compensator(s) is/are attached to the retort in order to provide a decoupling between the interior of the retort, the retort itself and the exterior of the retort. In the process, the dynamic forces and/or mass forces are decoupled.

It is preferable in this connection that the compensators are selected from the group consisting of springs and, preferably thin, sheets of metal. It can likewise be provided that the compensators are curved and constructed from thin sheets of metal in the form of a spring. It is particularly preferable that a material is selected for the compensators which can resist the temperatures found in the retort.

It is preferable that the compensators are flanged to the retort.

Particularly preferably, it is proposed that one or more compensator(s) is/are disposed adjacent to the jack legs. Jack legs are generally also known by the term “thrust bearings”.

It can be provided that the drive for moving the container is disposed outside the retort and is connected to the container by a drive rod leading into the retort.

It is also preferable that the retort be sealed at the point where the drive rod enters the retort.

In this case, it is preferable that one or more compensator(s) is/are disposed adjacent to the seal, so that even the friction of the seals can be decoupled.

Alternatively, the drive can be disposed inside the retort.

In this context, it is preferably proposed that one or more compensator(s) is/are attached to the retort adjacent to one or more drive supports.

It has surprisingly been found that by providing compensators on the retort, preferably on the retort wall, preferably in targeted positions, substantially complete decoupling between the drive and the pressurized vessel is possible, the seals are decoupled and are connected to the drive system, and all forces and vibrations can be dissipated directly into the foundation or the floor outside the pressurized vessel. With the pressurized retort of the invention, it is not necessary to change the pressurized vessel per se; on the contrary, standard retorts can be used and adapted accordingly. In accordance with the invention, it is possible to keep the container free from the high alternating loads that occur, since it is possible in particular to separate the forces acting on the retort container and drive, i.e. parts bearing forces are decoupled from the retort container, so that no flow of forces can occur. The overall consequence of this is that the pressurized retort can be operated substantially free of vibrations. In addition, it becomes apparent that the positioning of the drive, either outside or inside the retort container, is not of decisive importance for the pressurized retort of the invention. With the pressurized retort of the invention, it is likewise possible to design it with such a size that it is possible to sterilize and thus introduce a plurality of containers, even fairly large ones, into the retort simultaneously. With the pressurized retort of the invention, larger production facilities can therefore be designed, which lead to cost savings because of the higher throughput.

Further features and advantages of the pressurized retort of the invention will become apparent from the following detailed description of preferred embodiments in combination with the enclosed drawings.

### BRIEF DESCRIPTION OF THE DRAWINGS

FIG. 1 shows a first embodiment of a pressurized retort of the invention in cross-section; and

FIG. 2 shows a second embodiment of a pressurized retort of the invention in cross-section.

### DETAILED DESCRIPTION OF THE INVENTION

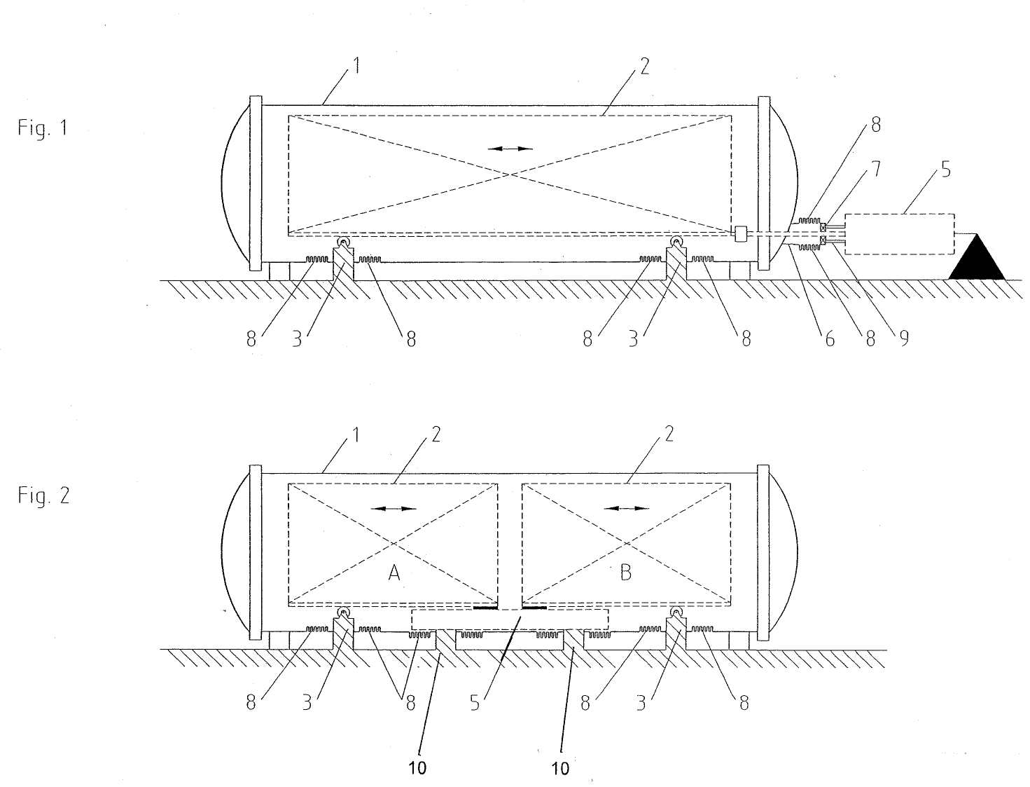

FIG. 1 shows a pressurized retort 1 in cross-section. Inside the retort 1 there is disposed a container 2, in which tins, for example, may be placed, in order to sterilize their contents. The container 2 is supported on two bearings 3, which connect to the floor. The container 2 is also connected via a drive rod 4 with a drive 5, which drive 5 likewise connects to the floor. Between the pressurized retort 1 or a pipe coupling 6 thereof, the drive rod 4 and the drive 5, a seal 7 is provided at the entry point of the drive rod 4 into the retort 1, which ensures a substantially complete seal of the interior of the retort 1. Forces are dissipated here via tie rods 9. Adjacent to the seal 7, compensators 8 are provided at the pipe coupling 6, such as in the form of springs or thin sheets of metal. Compensators 8 can likewise be found on the retort walls adjacent to the bearing 3.

During operation of the pressurized retort of the invention 1, the container 2 disposed in the retort 1 is moved to and fro horizontally via the drive 5, as indicated by the double arrow on the container 2. As a result of this movement, vibrations and forces are generated, but because of the arrangement of the compensators 8, they are decoupled from the pressurized retort 1. In this way, it is ensured that the pressurized retort 1 per se can be operated in a substantially low-vibration manner and that the parts of the retort 1 carrying forces are decoupled. This likewise prevents the introduction of mass forces into the pressurized retort 1, which result from an acceleration of the container 2. Instead, substantially all the forces are absorbed outside the retort housing and dissipated into the floor. All in all, the pressurized retort of the invention 1 can therefore be operated in a safe and efficient manner. In addition, sensitive parts of the pressurized retort, especially delicate accessories such as sensors, are protected against damage that might be caused by forces and vibrations.

A further embodiment is shown in FIG. 2, in which two containers 2 (A and B) are now disposed inside the pressurized retort 1. Also disposed and supported inside the retort 1, likewise substantially centrally, is the drive 5, which ensures that the containers A and B are moved to and fro in a reciprocating movement, so that in this case the dynamic forces can be substantially compensated. It goes without saying that the containers A and B can also be moved together first in one direction and then in the other, though this means that higher forces must be expected. Compensators 8 are disposed adjacent to the drive supports and adjacent to the bearing on the pressurized retort 1. With this embodiment too, the advantages of the pressurized retort 1 described above can be achieved.

The features of the invention disclosed in the above description, in the claims and in the drawings can be essential to implementing the invention in its various embodiments both individually and in any combination.

1. A pressurized retort with at least one container disposed therein, comprising:
a container being movable in the retort via a drive and the container being supported by at least one bearing in the retort, wherein one or more compensator(s) is/are attached to the retort to provide a decoupling between the interior of the retort, the retort itself and the exterior of the retort.

2. The retort as claimed in claim 1, wherein the compensators are selected from the group consisting of springs and sheets of metal.

3. The retort as claimed in claim 1, wherein one or more compensator(s) is/are disposed adjacent to the at least one bearing.

4. The retort as claimed in claim, wherein the drive for moving the container is disposed outside the retort and is connected to the container by a drive rod leading into the retort.

5. The retort as claimed in claim 4, wherein the retort is sealed at the point where the drive rod enters the retort.

6. The retort as claimed in claim 5, wherein one or more compensator(s) is/are disposed adjacent to the seal.

7. The retort as claimed in claim 1, wherein the drive is disposed and supported inside the retort.

8. The retort as claimed in claim 7, wherein one or more compensator(s) is/are attached to the retort adjacent to one or more drive supports.
